(19) United States
(12) Patent Application Publication
(10) Pub. No.: US 2025/0310386 A1
(43) Pub. Date: Oct. 2, 2025

(54) TECHNIQUES FOR IMPROVED SERVICE CALL SESSION INITIATION

(71) Applicant: T-Mobile USA, Inc., Bellevue, WA (US)

(72) Inventors: A. Karl Corona, Maple Valley, WA (US); Harikishore Allu Balan, Lynnwood, WA (US)

(21) Appl. No.: 18/620,867

(22) Filed: Mar. 28, 2024

(51) Int. Cl. H04L 65/1069; H04L 65/1016; H04L 65/1073

(52) U.S. Cl. CPC H04L 65/1069; H04L 65/1073; H04L 65/1016

(57) ABSTRACT

Techniques are described herein for providing improved service call initiation on an IMS network. In embodiments, such techniques are performed on an application server and may comprise upon receiving a request for a service to be initiated in relation to a user equipment, providing, to a second computing device, a query related to the user equipment. The techniques may further comprise receiving information related to a current status of the user equipment in response to the query, making, based on policy data associated with the service and the information related to the current status of the user equipment, an initiation decision related to the service, and providing, to the user equipment, instructions to initiate the service based on the initiation decision.

### BACKGROUND

Internet Protocol Multimedia Subsystem (IMS) is an architectural framework defined by the 3rd Generation Partnership Project (3GPP) for delivering Internet Protocol (IP) multimedia to user equipment (UE) of the IMS network. An IMS core network (sometimes referred to as the “IMS core”, the “Core Network (CN),” or the “IM CN Subsystem”) permits wireless and wireline devices to access IP multimedia, messaging, and voice applications and services. IMS allows for peer-to-peer communications, as well as client-to-server communications over an IP-based network.

During a registration procedure with the IMS core network, the UE is assigned a serving call session control function (S-CSCF) node and an application server (AS). These assigned nodes are tasked with serving the UE during a subsequent communication session, and all signaling originating from, and terminating at, the UE during the communication session is to be routed through the assigned nodes of the IMS core.

In a typical IMS network, a number of communications are routed between the various nodes in the IMS network in relation to IMS services requested by each UE. Each such communication may require interactions between a number of nodes in the network. When hundreds, or thousands, of UEs are requesting IMS services, this can result in a significant amount of bandwidth being dedicated to such communications, which can negatively impact the IMS network.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 depicts a diagram illustrating an overview of an IMS network having a number of nodes implemented in accordance with some embodiments.

FIG. 2 depicts a block diagram illustrating a process for performing a session initiation process when providing an IMS service in accordance with embodiments.

FIG. 3 depicts a swim lane diagram illustrating a process for optimizing initiation of a communication session for a service in accordance with at least some embodiments.

FIG. 4 depicts a block diagram illustrating an exemplary process for making a service initiation decision at an application server in accordance with embodiments.

FIG. 5 depicts a flow diagram illustrating an exemplary process for providing enhanced service initiation in an IMS network in accordance with at least some embodiments.

FIG. 6 shows an example computer architecture for an IMS node capable of executing program components for implementing the functionality described above.

### DETAILED DESCRIPTION

This disclosure describes techniques and systems for providing improved service session initiation over an IMS network. In embodiments, such techniques may include providing information about a UE (and/or an account associated with the UE) to an application server such that the application server is capable of performing enhanced server session initiation based on that information.

During operation, such as when an IMS service is to be provided to a UE on a terminating side of an IMS network, an application server sends a request (e.g., a SIP request) to the UE to initiate a communication session. In such cases, the application server may identify a S-CSCF node assigned to the UE during a registration process and may forward the request to that S-CSCF node. Upon receiving that request, the S-CSCF node would typically then forward that request to a P-CSCF node assigned to the UE, which then forwards the request to the UE itself. The UE can then initiate the communication session in response to that request. However, in some cases, the requested service cannot be provided to the UE. In some examples, this may occur because the UE is in an area that does not have sufficient coverage, is not operating on a network that supports the service, or is in an area within which the service is prohibited. While the UE in these cases may ultimately make a determination that the communication session cannot be established, all of the communications between the nodes in the IMS network up to that point can represent a significant use of resources (e.g., bandwidth).

In embodiments as described herein, when a request is received at an application server that is directed to a terminating UE, the application server may make a decision about initiation of the service prior to sending any communications to the UE, resulting in freeing up valuable resources on the IMS network. To do this, the application server may send a query (e.g., via a Diameter interface) to a home subscriber server for information related to a current status of the terminating UE. The home subscriber server may in turn, upon receiving such a query, submit a query to another entity that manages mobile operations for a network (e.g., a mobile management entity).

In embodiments, a mobile management entity may receive periodic status update communications from a number of UEs operating on a network and may store a current status for each of those UEs. When the mobile management entity receives a query for information related to the terminating UE, it may retrieve various data values for that UE to be provided in a response. In some nonlimiting examples, such data values may indicate location data (e.g., geographic coordinates), a cell identifier for a cell currently in communication with the UE, a PLMN code, and/or a RAT type for the UE. These data values are provided back to the home subscriber server, which in turn provides them to the application server.

Once the application server has received data values related to the current status of the UE, it may make a decision about the initiation of the service based on those data values and based on policy data. For example, the application server may make a decision not to initiate the service based on the UE currently being in an area in which the service is not supported. This decision may be made if geographic coordinates of the UE are (or are not) within one or more regions indicated in the policy data. In another example, the application server may make a decision not to initiate the service based on one or more conditions indicated in the policy data. For example, account information provided by the home subscriber server may indicate that the UE is provided access to a service within a certain range of dates/times. In this example, the application server may not initiate the service if a current date/time is outside of that range.

Embodiments of the disclosure provide for a number of advantages over conventional systems. For example, the implemented system allows for information about user equipment (and/or a user account) to be retrieved by an application server (e.g., from an entity outside of the IMS network). In this example, when an application server receives a request that is directed to a particular user equipment, that application server can communicate with another computing device that provides mobility management for the equipment in a network to receive information about that user equipment. Such information may include location data, a cell identifier (e.g., for a cell that is currently in communication with the user equipment), a Public Land Mobile Network (PLMN) code, or a Radio Access Technology (RAT) type for the user equipment. Upon receiving the information about the user equipment, the application server can make advanced server initiation decisions while minimizing communications transmitted over the IMS network. This reduces the impact that providing IMS services has on the IMS network while also allowing policy decisions to be made faster and using fewer resources.

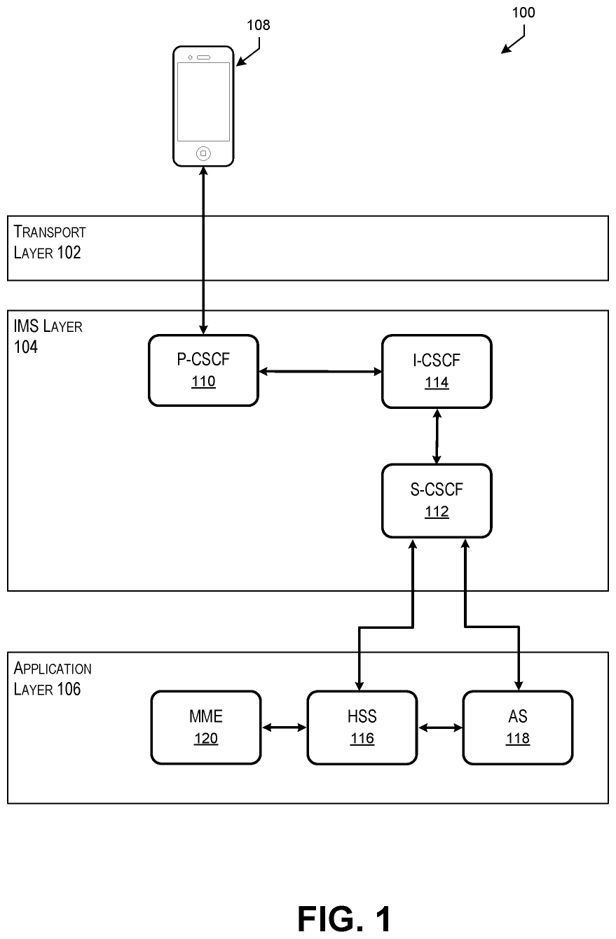

FIG. 1 depicts a diagram illustrating an overview of an IMS network 100 having a number of nodes implemented in accordance with some embodiments. In embodiments, the IMS network 100 may be made up of multiple layers, each of which includes a different set of nodes. For example, the IMS network may include at least a transport layer 102, an IMS layer 104, and an application layer 106.

A transport layer 102 may include any node (e.g., equipment) configured to provide access (e.g., ingress/egress) to the IMS network 100 for a number of user equipment (UE) 108. For example, a transport layer 102 may include a gateway device, such as a gateway that provides fixed access (e.g., digital subscriber line (DSL), cable modems, Ethernet, FTTx), mobile access (e.g., 5G NR, LTE, W-CDMA, CDMA2000, GSM, GPRS), and/or wireless access (e.g., WLAN, WiMAX).

An IMS layer 104 (also referred to as a control layer) may include any node configured to process SIP signaling packets within the IMS network 100. Such nodes may generally be referred to as Call Session Control Function (CSCF) nodes. CSCF nodes can be further distinguished based on their respective roles. For example, CSCF nodes may include a Proxy CSCF (P-CSCF), a Service CSCF (S-CSCF), and an Interrogating CSCF (I-CSCF). It is to be appreciated that the IMS network can include additional nodes that are not described herein such as nodes including, without limitation, an emergency CSCF (E-CSCF) node, a security gateway (SEG), a session border controller (SBC), and so on.

A P-CSCF node is a proxy device that acts as a first point of contact for UE 108 within the IMS Network. Each UE is assigned to a respective P-CSCF when it is registered with the IMS Network. A P-CSCF node can receive, via a communications interface, a Session Initiation Protocol (SIP) request from the UE 108 to be forwarded to a S-CSCF.

A S-CSCF node is the central nodes of the signaling plane and sits on the path of all signaling messages to/from a UE 108 that is assigned to it. There can be multiple S-CSCFs in the network for load distribution and high availability reasons. A S-CSCF is typically assigned to a user (or UE) by a Home Subscriber Server (HSS), when it's queried by the I-CSCF.

A S-CSCF node 112 may represent one of multiple available S-CSCF nodes (e.g., 112 (A-C)) that is chosen (or otherwise selected) for assignment to the UE 108. S-CSCF nodes, such as the S-CSCF node 112 (A), are sometimes referred to as “Registrars,” and the process of allocating Registrars among users who are registering for IMS-based services is sometimes referred to as finding a “home CSCF” for the UE 108.

A I-CSCF node 114 is a SIP function node that acts as a forwarding point for external devices. The I-CSCF node 114 queries the HSS to determine S-CSCF/UE mapping and forwards SIP requests between the P-CSCF node 110 and the respective S-CSCF node 112.

An application layer 106 (also referred to as a service layer) may include one or more nodes capable of providing IMS-related services to the UE 108. In embodiments, the application layer 106 may include at least a Home Subscriber Server (HSS) 116, a number of Application Servers (AS) 118, as well as a Mobility Management Entity (MME) 120. Note, however, that while the HSS 116 and/or the MME 120 is described as being included in an application layer, either entity may be included in an IMS layer in some embodiments of an IMS network 100 or even outside of the IMS network.

The HSS 116 is typically a master user database that supports the IMS network nodes that handle the calls/sessions. It contains user profiles, performs authentication and authorization of the user, and can provide information about the physical location of a user. A user profile may be associated with each UE 108 and may contain information about the current user. Such information may be downloaded by the S-CSCF assigned to the user when the user is registered on the network. The S-CSCF may typically receive that information in a User-data Attribute Value Pair (AVP) format.

An AS 118 hosts and executes services, and interface with the S-CSCF using messages formatted using a SIP protocol. Depending on the actual service, the AS 118 can operate in SIP proxy mode, SIP UA (user agent) mode or SIP B2BUA mode. An AS can be located in the IMS network 100 or in an external third-party network. If located in the IMS network 100, it may be able to query, or otherwise interact with the HSS 116 (e.g., using Diameter interfaces). In embodiments, the AS 118 manages an application that provides communication between two or more UEs (e.g., UE 108 and at least one other UE). For example, the AS may manage an application that provides Voice over IP (VOIP) communications between UE devices.

In embodiments, an AS 118 may be configured to make service initiation decisions based on information about a UE 108 to which a communication is being directed. For example, the AS 118 may receive a communication directed to initiation of a service at a UE 108. By way of illustration, another UE may initiate a Voice over Internet Protocol (VOIP) call to a UE 108. In this illustration, the AS 118 receives a request to initiate the VoIP call as well as an identifier for the UE 108. Upon receiving such a communication, the AS 118 may retrieve information about the UE 108 from a second entity that maintains updated information about a status of the UE 108. Such a communication may be routed through the HSS 116. For example, the AS 118 may provide a request to the HSS 116 (which maintains information about services associated with the account for that UE 108) and the HSS 116 further communicates with an MME 120 to retrieve such information. The AS 118 may then make a determination about whether the service should or should not be initiated based on the received information and absent additional communications within the IMS network 100.

The UE 108 may include any electronic device capable of interacting with the IMS network 100. In some non-limiting examples, the UE 108 may be a variety of devices including, for example: a mobile phone, a personal data assistant (PDA), or a mobile computer (e.g., a laptop, notebook, notepad, tablet, etc.) having mobile wireless data communication capability. The UE 108 may be configured to register for, and thereafter access and utilize, one or more IMS-based services via the IMS network 100. To this end, the UE 108 may be configured to transmit, via a radio access network (RAN), messages to the IMS network. For example, the UE 108 may transmit messages to the IMS network as part of an IMS registration procedure where the UE 108 is requesting to register for an IMS-based service.

In operation, the UE 108 may, upon registration with the IMS network 100, initially be assigned to a P-CSCF node 110 as well as a S-CSCF node 112 (A). Communications from the UE 108 to an AS 118 of the IMS network 100 are then routed from the UE 108 to the P-CSCF node 110 and then to the S-CSCF node 112 (A) (through forwarding by the I-CSCF node 114) and subsequently to the AS 118. Conversely, communications from an AS 118 of the IMS network 100 to the UE 108 are routed from the AS 118 to the S-CSCF node 112 (A) and then to the P-CSCF node 110 and subsequently to the UE 108.

During operation, services may be initiated between UEs via an application managed by, and executed on, an AS 118. In such cases, each of the UEs involved in the service session may be independently connected to the AS 118 over different nodes of an IMS network 100 distributed over a geographic area. In such cases, the two UEs may be geographically remote, such that they are otherwise unable to establish a direct communication session. When a communication session is initiated via a service offered by an AS 118, communications between the two UEs is routed through that AS 118.

As noted elsewhere, the AS 118 is configured to make one or more service initiation decisions upon receiving a communication directed to a UE 108. In some embodiments, such decisions may be made based on a current location of the UE 108. For example, a determination may be made as to whether the service is available to the UE 108 based on that location. In one case, a determination may be made as to whether the UE is currently located in a region in which the service is restricted or blocked. In another case, the determination may be made as to whether a network operated on a cell that is currently supporting the UE is able to provide the requested service. By way of illustration, if the service requires operation on a 5G network, then a determination may be made not to provide the service if the UE only has 4G service.

In accordance with various embodiments described herein, the terms “user equipment (UE),” “wireless communication device,” “wireless device,” “communication device,” “mobile device,” and “client device,” may be used interchangeably herein to describe any UE (e.g., the UE 108) that is capable of transmitting/receiving data over the IMS network, perhaps in combination with other networks. A users can utilize the UE 108 to communicate with other users and associated UEs via the IMS network. For example, a service provider may offer multimedia telephony services that allow a subscribed user to call or message other users via the IMS network using his/her UE 108. A user can also utilize the UE 108 to receive, provide, or otherwise interact with various different IMS-based services by accessing the IMS network. In this manner, an operator of the IMS network may offer any type of IMS-based service, such as, telephony services, emergency services (e.g., E911), gaming services, instant messaging services, presence services, video conferencing services, social networking and sharing services, location-based services, push-to-talk services, and so on.

Furthermore, the IMS network that includes the IMS nodes 110-114 may enable peer-to-peer, client-to-client, and/or client-to-server, communications over wired and/or wireless networks using any suitable wireless communications/data technology, protocol, or standard, such as Global System for Mobile Communications (GSM), Time Division Multiple Access (TDMA), Universal Mobile Telecommunications System (UMTS), Evolution-Data Optimized (EVDO), Long Term Evolution (LTE), Advanced LTE (LTE+), Generic Access Network (GAN), Unlicensed Mobile Access (UMA), Code Division Multiple Access (CDMA), Orthogonal Frequency Division Multiple Access (OFDM), General Packet Radio Service (GPRS), Enhanced Data GSM Environment (EDGE), Advanced Mobile Phone System (AMPS), High Speed Packet Access (HSPA), evolved HSPA (HSPA+), Voice over IP (VOIP), Voice over LTE (VOLTE), IEEE 802.1x protocols, WiMAX, Wi-Fi, Data Over Cable Service Interface Specification (DOCSIS), digital subscriber line (DSL), and/or any future IP-based network technology or evolution of an existing IP-based network technology.

The IMS network 100 of FIG. 1 may be maintained and/or operated by one or more service providers, such as one or more wireless carriers (“operators”), that provide mobile IMS-based services to users (sometimes called “subscribers”) who are associated with UEs, such as the UE 108. The IMS network may represent any type of SIP-based network that is configured to handle/process SIP signaling packets or messages. SIP is a signaling protocol that can be used to establish, modify, and terminate multimedia sessions (e.g., a multimedia telephony call) over packet networks, and to authenticate access to IMS-based services. Individual nodes of the IMS nodes 110-114 of FIG. 1 can also be configured to transmit data to/from the HSS 116 using Diameter protocol over a Diameter interface. In one example, such a Diameter interface may be a Diameter (Cx) when the interface is accessed via a I/S-CSCF node. In another example, such a Diameter interface may be a Diameter (Sh) when the interface is accessed via an application server. Diameter protocol is defined by the Internet Engineering Task Force (IETF) in RFC 6733.

For clarity, a certain number of components are shown in FIG. 1. It is understood, however, that embodiments of the disclosure may include more than one of each component. In addition, some embodiments of the disclosure may include fewer than or greater than all of the components shown in FIG. 1. In addition, the components in FIG. 1 may communicate via any suitable communication medium (including the Internet), using any suitable communication protocol.

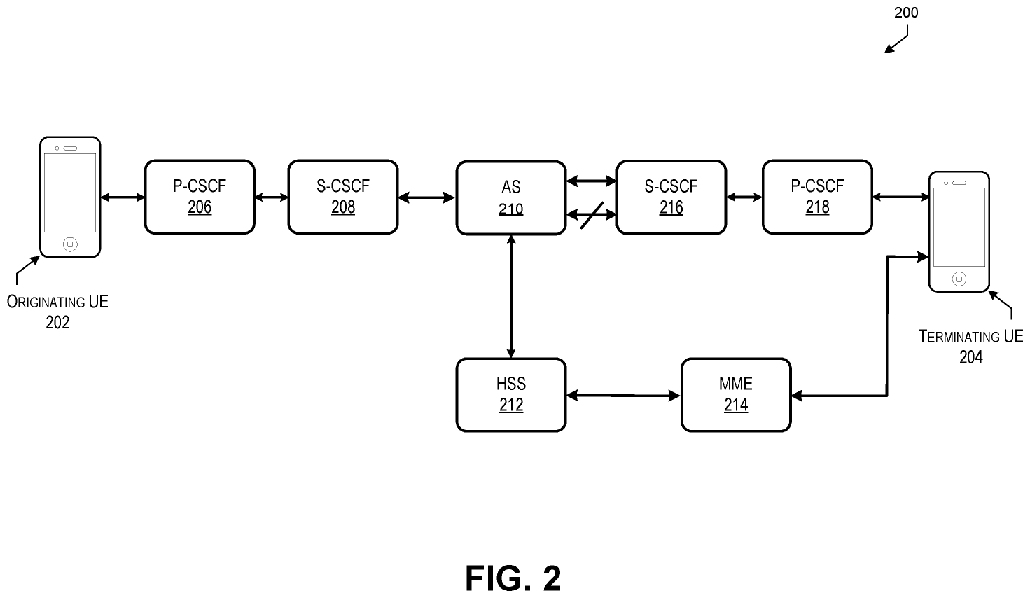

FIG. 2 depicts a block diagram illustrating a process for performing a session initiation process when providing an IMS service in accordance with embodiments. In FIG. 2, the process 200 is represented as a number of interactions between various components of an IMS network. In embodiments, the components depicted in FIG. 2 may be examples of the components described in relation to the IMS network 100 as depicted in FIG. 1 above. For the purposes of the example depicted in FIG. 2, the IMS service is establishing a communication session between two UEs connected to the IMS network, and particularly, between an originating UE 202 and a terminating UE 204.

In an exemplary process 200, an originating UE 202 may initiate a communication session by sending a SIP request to a P-CSCF node 206 assigned to the UE during a registration of that UE 202. The P-CSCF node 206 then forwards the communication to the S-CSCF node 208 assigned to the P-CSCF node 206 (e.g., via forwarding through a I-CSCF node). The S-CSCF node 208 then relays the communication to an AS 210 included in an application layer of an IMS core of the IMS network.

In embodiments, upon receiving the request for a service to be implemented with respect to the terminating UE 204, the AS 210 may submit a query for information about the terminating UE 204. As noted elsewhere, such a query may be submitted to the HSS 212 and may include at least an identifier for the termination UE 204. In some cases, the query may further include an indication of one or more data values that are requested in relation to the service to be implemented.

Upon receiving a query from AS 210, the HSS 212 may forward that query to an entity that provides access and mobility management for one or more user devices operating on a mobile network. In embodiment, such an entity may be a mobility management entity (MME) 214 that receives periodic updates (e.g., heartbeat information) from cell towers in communication with UEs operating on a network. The MME 214 may retrieve the relevant information (e.g., data field values) for the query from one or more databases that it maintains.

Once the MME 214 has retrieved the relevant data, it may provide a response to the query back to the HSS 212. The HSS 212 then forwards that response back to the AS 210. Additionally, the HSS 212 may provide additional information about the terminating UE 204 (e.g., name, address, capabilities, etc.) to which the service is directed as obtained from a database of account data managed by the HSS 212.

Upon receiving a response to the query, the AS 210 may make a determination as to whether it should continue to initiate a communication session with the terminating UE 204 or alternatively whether the request to initiate a service should be declined. In some embodiments, this may involve making a determination about whether a service related to the requests received from the originating UE 202 is available in a region that the terminating UE 204 is currently located. In some embodiments, this may involve making a determination about whether a service related to the requests received from the originating UE 202 is operable on a particular network that the terminating UE 204 is currently operating over.

Provided that the AS 210 makes a determination to initiate a communication session with the terminating UE 204, the application server identifies the S-CSCF node 216 as being associated with the terminating UE 204. The application server may make such a determination based on the information provided by the HSS 212 based on an assignment of the S-CSCF node 216 to the UE 204. The AS 210 sends a communication (e.g., a SIP request) to the S-CSCF node 216. The S-CSCF node 216, upon receiving that communication, then relays the communication to the P-CSCF node 218, which forwards the communication to the terminating UE 204.

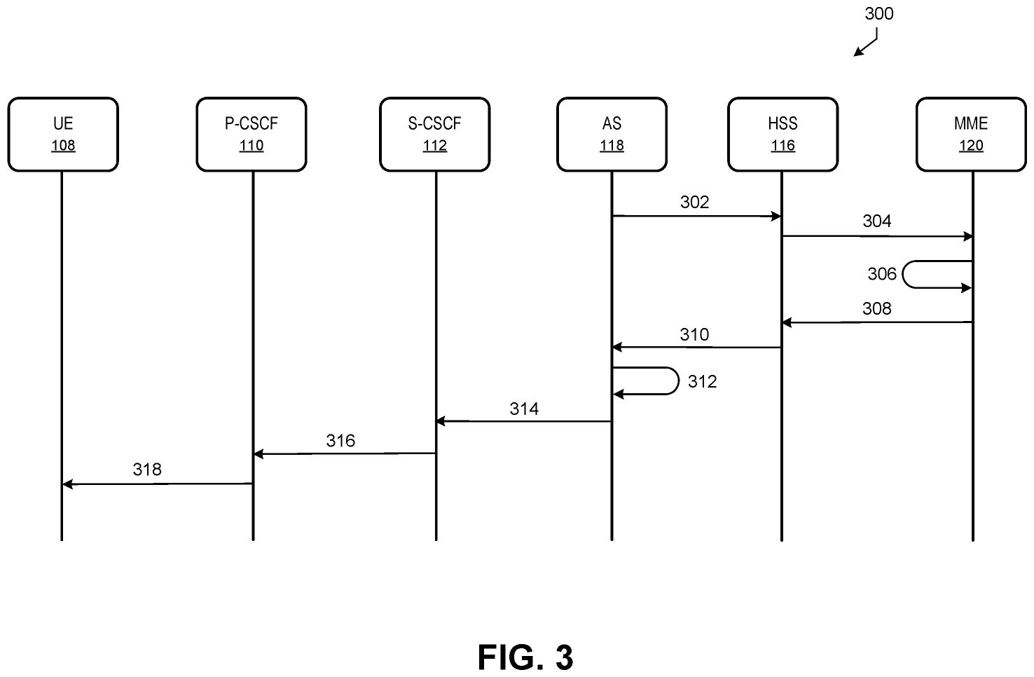

FIG. 3 depicts a swim lane diagram illustrating a process for optimizing initiation of a communication session for a service in accordance with at least some embodiments. More particularly, the block diagram illustrates example signaling between a UE (e.g., UE 108) and various IMS nodes within the IMS network to intelligently initiate a communication session for the UE while minimizing requests sent to the UE.

As noted elsewhere, a UE 108 may be assigned to both a P-CSCF node 110 as well as a S-CSCF node 112 during a registration process for the UE 108. In embodiments, information transmitted between the various nodes in the IMS network may be provided to the HSS 116 over a Diameter interface in the form of a profile update request (PUR) message.

The HSS 116 can be associated with a master database (sometimes referred to herein as an “HSS repository”) that maintains data pertaining to UEs that have registered, or are in the process of registering, on the IMS network. It should be noted that the HSS 116 may receive information about the UE 108 and/or an account associated with the UE 108. In some cases, this information may be obtained from the UE 108 itself. In other cases, this information may be provided independently by a user associated with the UE upon registration of that user with one or more services offered on the network.

In the process 300, an AS 118 may receive a request to initiate a communication session in relation to a service that is offered by that AS 118. In some cases, such a request may originate at another UE (e.g., an originating UE). In other cases, such a request may originate at the AS 118 itself (or another AS). For example, the AS 118 may be configured to initiate a service upon certain conditions being met (e.g., at a particular time, etc.).

At 302, upon receiving the request to initiate a service for the UE 108, the AS 118 may retrieve information about the UE 108. In embodiments, this may involve submitting a query to a HSS 116 in relation to the UE 108. Such a query may be sent over a Diameter interface in the form of a profile information request and may include at least an identifier for the UE 108. In embodiments, such an information request may be formatted as a User Data Request (UDR) that is provided over a Diameter (Sh) interface.

At 304, upon receiving a query related to a UE 108, the HSS 116 may retrieve information about the UE from a master user database. Such information may include any suitable data values related to the UE. In some cases, the information may include an indication of one or more services available to the UE. In some cases, the information may include an indication of one or more constraints related to the operation of the UE (e.g., where/when a service can be used, data limits, etc.). In addition, the HSS 116 may generate a query to another entity (e.g., MME 120) to retrieve information that relates to a current status of the UE 108.

As noted elsewhere, a MME 120 may manage mobile operations for a UE 108. In embodiments, the MME 120 receives information about the UE at periodic intervals. For example, the MME 120 may receive and store information about a current cell/base station that is in communication with (i.e., supporting) the UE 108. As the UE is handed off to a different base station, information about that handoff is received at the MME 120. In some embodiments, each of the UEs operating on a network (e.g., a cellular network) may periodically send status update communications (e.g., “heartbeat” communications) over the network. The MME 120 may receive at least a portion of the information included in such status update communications. For example, the MME 120 may receive information about a location of the UE as included in such a status update communication. In this example, such location information may be global positioning system (GPS) coordinates collected by a GPS device included in the UE.

Upon receiving a query related to a particular UE at 304, the MME 120 may retrieve information related to that UE from a database managed by the MME at 306. In some embodiments, such information related to the UE may include, but is not limited to, location data (e.g., geographic coordinates), a cell identifier for a cell currently in communication with the UE, a PLMN code, and/or a RAT type for the UE. The MME 120 may then provide the retrieved information in response to the received query at 308.

Upon receiving information about the UE in response to the query sent to the MME 120, the HSS 116 routes that information to the AS 118 at 310. In some cases, the HSS 116 may include additional information to be provided back to the AS 118. For example, the HSS 116 may append at least a portion of the information related to the UE as retrieved at 304 to the response provided to the AS 118.

Upon receiving the information about the UE 108 in response to the query, the AS 118 may make one or more determinations about the service to be provided at 312. In some cases, such a determination may include a determination as to whether or not to initiate the service in accordance with the received request. In other cases, such a determination may include a determination as to a manner in which the service should be initiated. For example, such a determination may include a determination of a format or protocol that should be used to communicate with the UE.

At 314, upon making a determination that the service associated with the request is to be initiated with the UE 108, the AS 118 initiates a communication session with the UE 108 by providing a SIP request to the S-CSCF node 112 assigned to that UE. That SIP request is then forwarded by the S-CSCF node 112 to the P-CSCF node 110 at 316. The SIP request is then forwarded to the UE 108 at 318, which subsequently initiates the communication session. As noted elsewhere, the P-CSCF node 110 and the S-CSCF node 112 are assigned to a UE 108 when that UE 108 is registered to the IMS network.

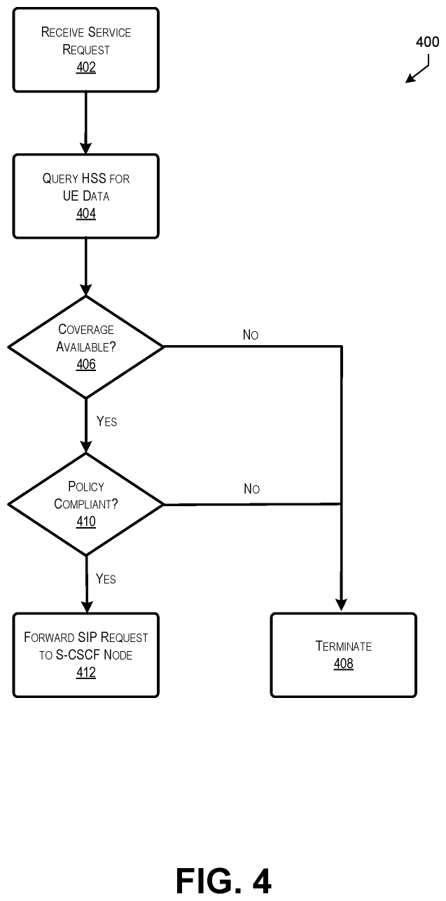

FIG. 4 depicts a block diagram illustrating an exemplary process for making a service initiation decision at an application server in accordance with embodiments. The process 400 may be performed by an application server as implemented in an IMS network of the disclosed system.

At 402, an application server may receive a request to initiate a service with respect to a particular UE. The service provided by an application server may represent any suitable multimedia communications services such as voice, video and text messaging over IP networks. In some cases, a request for a service may include at least an identifier for the particular UE on which the service is to be initiated.

In some cases, the request for a service may originate from an electronic device outside of the IMS core, such as at another UE. For example, another UE may initiate a VoIP session that is directed to the target UE. In some cases, the request for a service may originate from the applications server itself. For example, the application server may be configured to initiate a service upon certain conditions being met (e.g., a date/time being reached, one or more data usage limits being reached, etc.).

Upon receiving the request to initiate a service with respect to the UE, the application server may submit a query to a HSS at 404. The HSS may be any suitable computing device that maintains information about the UE, such as a HSS (e.g., HSS 116 as described in relation to FIG. 1 above). Upon receiving the query, the HSS may forward that query (or a portion thereof) to an MME to obtain current status information for the UE.

The MME may periodically receive status update communications from each of the UEs operating on a network and/or within a region. Information included in such status update communications may be stored as current status data within a database maintained by the MME. As a new status update communication is received from a UE, the current status data may be updated (e.g., overwritten or appended) to reflect the information included in that recent message. Upon receiving a query from the HSS, the MME may retrieve at least a portion of the current status data that it has stored in relation to the UE and may provide that data back to the HSS in a response.

Upon receiving the current status data from the MME, the HSS relays that data back to the application server. In some cases, the HSS may include or append additional information about the UE to the response. By way of nonlimiting example, the HSS may include information about an account associated with the UE, a type or model for the UE, a software version for the UE, a level of service associated with the UE, or any other suitable information as related to the UE.

At 406, the application server may make a determination about whether the service is available to the UE. More particularly, this may involve determining if there is coverage for the service available to the UE. In some cases, this may involve comparing a cell identifier for a current cell (e.g., base station) that is supporting the UE against a list of cell identifiers that are able to or are not able to provide the service. In some cases, this may involve comparing a current location of the UE against a coverage map to determine whether the UE has sufficient coverage to receive the service. In some cases, this may involve determining whether the service can be provided over a type of network that the UE is currently operating on.

If a determination is made that the service is not available to the UE (e.g., “No” from 406), the application server may elect to terminate the request to initiate the service at 408. In other words, rather than provide instructions to the UE to initiate a communication session for the service, the application server may simply drop the request. In some cases, the application server may provider a response to the originator of the request indicating that the service is unavailable.

Provided that a determination is made that the service is available to the UE (e.g., “Yes” from 406), the application server may further make a determination as to whether the requested service is compliant with various policies maintained by the application server. In some cases, the policy data may include information about usage requirements such as dates/times that the service can be implemented. In some cases, the application server may receive information about an account associated with the UE (e.g., form the HSS at 404) and may make a determination as to whether that information is consistent with the policy data. For example, a level or status of the account associated with the UE may be compared to a level or status needed to use the service in order to determine if the UE qualifies to use the service. In some cases, the information about the UE may include information about data usage limits (e.g., a maximum bandwidth, or a maximum total data per time period) such that the service will not be provided if those data usage limits would be exceeded.

Provided that a determination is made that the service is compliant with the one or more policies (e.g., “Yes” from 410), the application server may generate a SIP request to initiate the service. The SIP request is provided to a S-CSCF node assigned to the UE in order to be routed to the UE (e.g., via a P-CSCF node also assigned to the UE). If a determination is made that the service is not compliant with the one or more policies (e.g., “No” from 406), the application server may elect to terminate the request to initiate the service at 408.

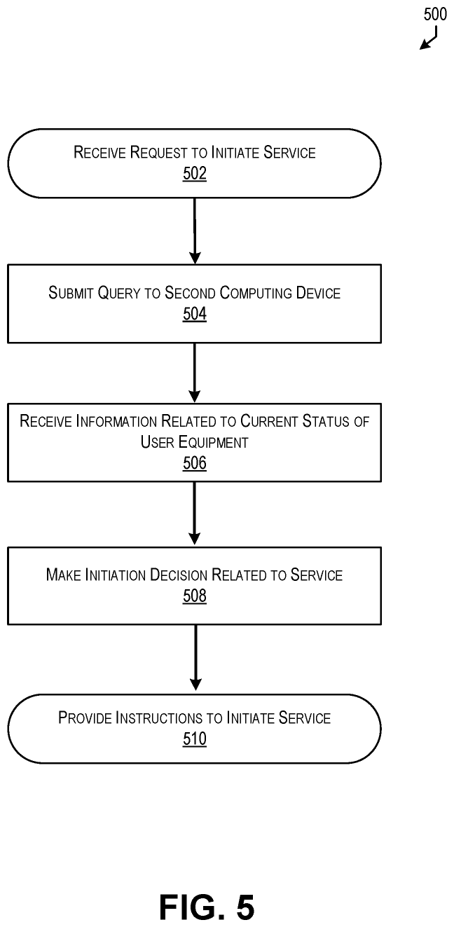

FIG. 5 depicts a flow diagram illustrating an exemplary process for providing enhanced service initiation in an IMS network in accordance with at least some embodiments. In embodiments, the process 500 as depicted in FIG. 5 may be performed by an application server as implemented within an IMS network.

At 502, the process 500 may involve receiving a request to initiate a service at an indicated UE. In embodiments, the service may represent a service for voice, video and text messaging provided over an IMS network.

At 504, the process 500 may involve submitting a query to a second computing device for information about the indicated UE. As noted elsewhere, a second computing device in this case may be a HSS that manages account information for a plurality of UEs operating on the IMS network. Upon receiving the query, the HSS may be caused to forward that query to a mobile management entity (MME) that manages mobile operations for a number of UEs operating on the IMS network.

At 506, the process 500 may involve receiving information related to a current status of the user equipment from the second computing device in response to the query. In embodiments, the current status of the user equipment comprises at least one of geographic coordinates, a cell identifier, a PLMN code, or a RAT type associated with the user equipment.

At 508, the process 500 may involve making an initiation decision based on the information related to the current status of the user equipment and policy data. In embodiments, the initiation decision comprises a decision as to whether the service should be initiated. In one example, the policy data includes an indication of one or more regions and the initiation decision is made based on whether a current location of the user equipment indicated in the information related to the current status of the user equipment is within the one or more regions. In one example, the policy data includes an indication of a radio access type and the initiation decision is made based on whether RAT type of the user equipment indicated in the information related to the current status of the user equipment. In yet another example, the policy data includes an indication of a set of cell identifiers and the initiation decision is made based on whether a current cell identifier associated with the user equipment is within the set of cell identifiers.

In embodiment, the policy data may include an indication of one or more conditions during which the user equipment is authorized to initiate the service. For example, the one or more conditions may be determined based on a level of service attributed to an account associated with the user equipment. In this example, the level of service attributed to the account may be provided to the application server by the second computing device (e.g., in response to the query).

At 510, the process 500 may involve providing instructions to the user equipment to initiate the service. In some cases, providing the instructions to initiate the service includes providing the instructions to a S-CSCF node assigned to the user equipment. In such cases, the S-CSCF node (as well as a P-CSCF node) is assigned to the user equipment during a registration process for the user equipment. In embodiments, the communication is a session initiation protocol (SIP) invite communication. In embodiments, the application server does not communicate with the user equipment between receiving the request for the service and providing the instructions to initiate the service.

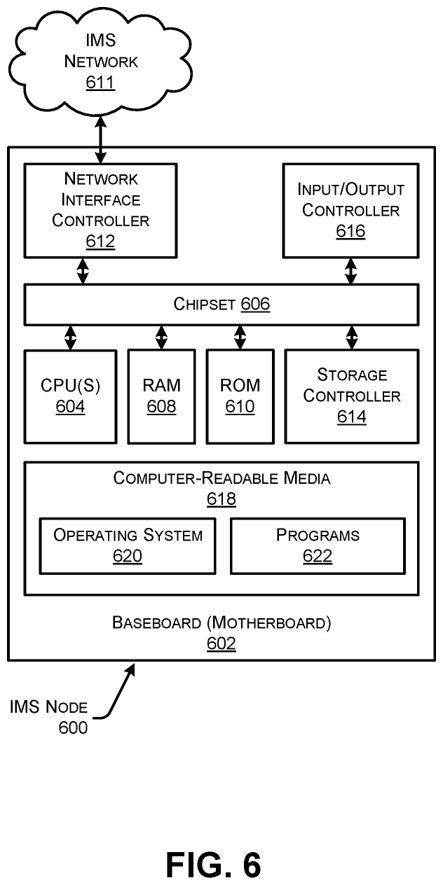

FIG. 6 shows an example computer architecture for an IMS node 600 capable of executing program components for implementing the functionality described above. The computer architecture shown in FIG. 6 illustrates a conventional server computer, workstation, desktop computer, laptop, tablet, network appliance, e-reader, smartphone, or other computing device, and can be utilized to execute any of the software components presented herein. The IMS node 600 may, in some examples, correspond to a physical server as described herein, and may comprise networked devices such as servers, switches, routers, hubs, bridges, gateways, modems, repeaters, access points, etc.

The IMS node 600 includes a baseboard 602, or “motherboard,” which is a printed circuit board to which a multitude of components or devices can be connected by way of a system bus or other electrical communication paths. In one illustrative configuration, one or more central processing units (“CPUs”) 604 operate in conjunction with a chipset 606. The CPUs 604 can be standard programmable processors that perform arithmetic and logical operations necessary for the operation of the IMS node 600.

The CPUs 604 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 606 provides an interface between the CPUs 604 and the remainder of the components and devices on the baseboard 602. The chipset 606 can provide an interface to a RAM 608, used as the main memory in the IMS node 600. The chipset 606 can further provide an interface to a computer-readable storage medium such as a read-only memory (“ROM”) 610 or non-volatile RAM (“NVRAM”) for storing basic routines that help to startup the IMS node 600 and to transfer information between the various components and devices. The ROM 610 or NVRAM can also store other software components necessary for the operation of the IMS node 600 in accordance with the configurations described herein.

The IMS node 600 can operate in a networked environment using logical connections to remote computing devices and computer systems through a network, such as the network 611 (which may be an IMS network). The chipset 606 can include functionality for providing network connectivity through a NIC 612, such as a gigabit Ethernet adapter. The NIC 612 is capable of connecting the IMS node 600 to other computing devices over the network 611. It should be appreciated that multiple NICs 612 can be present in the IMS node 600, connecting the computer to other types of networks and remote computer systems.

The IMS node 600 can be connected to a storage device 618 that provides non-volatile storage for the computer. The storage device 618 can store an operating system 620, programs 622, and data, which have been described in greater detail herein. The storage device 618 can be connected to the IMS node 600 through a storage controller 614 connected to the chipset 606. The storage device 618 can consist of one or more physical storage units. The storage controller 614 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The IMS node 600 can store data on the storage device 618 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 618 is characterized as primary or secondary storage, and the like.

For example, the IMS node 600 can store information to the storage device 618 by issuing instructions through the storage controller 614 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The IMS node 600 can further read information from the storage device 618 by detecting the physical states or characteristics of one or more particular locations within the physical storage units.

In addition to the mass storage device 618 described above, the IMS node 600 can have access to other computer-readable storage media to store and retrieve information, such as program modules, data structures, or other data. It should be appreciated by those skilled in the art that computer-readable storage media is any available media that provides for the non-transitory storage of data and that can be accessed by the IMS node 600. In some examples, the operations performed by devices as described herein may be supported by one or more devices similar to IMS node 600. Stated otherwise, some or all of the operations performed by an edge device, and/or any components included therein, may be performed by one or more IMS node 600 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 618 can store an operating system 620 utilized to control the operation of the IMS node 600. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 618 can store other system or application programs and data utilized by the IMS node 600.

In one embodiment, the storage device 618 or other computer-readable storage media is encoded with computer-executable instructions which, when loaded into the IMS node 600, transform the computer from a general-purpose computing system into a special-purpose computer capable of implementing the embodiments described herein. These computer-executable instructions transform the IMS node 600 by specifying how the CPUs 604 transition between states, as described above. According to one embodiment, the IMS node 600 has access to computer-readable storage media storing computer-executable instructions which, when executed by the IMS node 600, perform the various processes described above with regard to the other figures. The IMS node 600 can also include computer-readable storage media having instructions stored thereupon for performing any of the other computer-implemented operations described herein.

The IMS node 600 can also include one or more input/output controllers 616 for receiving and processing input from a number of input devices, such as a keyboard, a mouse, a touchpad, a touch screen, an electronic stylus, or other type of input device. Similarly, an input/output controller 616 can provide output to a display, such as a computer monitor, a flat-panel display, a digital projector, a printer, or other type of output device. It will be appreciated that the IMS node 600 might not include all of the components shown in FIG. 6, can include other components that are not explicitly shown in FIG. 6, or might utilize an architecture completely different than that shown in FIG. 6.

As described herein, the IMS node 600 may include one or more hardware processors (e.g., CPUs 604) (processors) configured to execute one or more stored instructions. The processor(s) may comprise one or more cores. Further, the IMS node 600 may include one or more network interfaces configured to provide communications between the IMS node 600 and other devices, such as the communications described herein as being performed by an edge device. The network interfaces may include devices configured to couple to personal area networks (PANs), wired and wireless local area networks (LANs), wired and wireless wide area networks (WANs), and so forth. More specifically, the network interfaces include the mechanical, electrical, and signaling circuitry for communicating data over physical links coupled to the network 611. The network interfaces may be configured to transmit and/or receive data using a variety of different communication protocols. Notably, a physical network interface may also be used to implement one or more virtual network interfaces, such as for virtual private network (VPN) access, known to those skilled in the art. In one example, the network interfaces may include devices compatible with Ethernet, Wi-Fi™, and so forth.

The programs 622 may comprise any type of programs or processes to perform the techniques described in this disclosure. The programs 622 may comprise any type of program that cause the IMS node 600 to perform techniques for communicating with other devices using any type of protocol or standard usable for determining connectivity.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

In various embodiments, as detailed further below, IMS node 600 may also include computer executable instructions that, when executed by processor(s), utilize machine learning. In general, machine learning is concerned with the design and the development of techniques that take as input empirical data (such as network statistics and performance indicators) and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), the model M can be used very easily to classify new data points. Often, M is a statistical model, and the cost function is inversely proportional to the likelihood of M, given the input data.

In various embodiments, the IMS node 600 may employ one or more supervised, unsupervised, or semi-supervised machine learning models. Generally, supervised learning entails the use of a training set of data, as noted above, that is used to train the model to apply labels to the input data. For example, the training data may include sample telemetry that has been labeled as normal or anomalous. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example machine learning techniques that path evaluation process can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for time series), random forest classification, or the like.

The performance of a machine learning model can be evaluated in a number of ways based on the number of true positives, false positives, true negatives, and/or false negatives of the model. For example, the false positives of the model may refer to the number of times the model incorrectly predicted an undesirable behavior of a path, such as its delay, packet loss, and/or jitter exceeding one or more thresholds. Conversely, the false negatives of the model may refer to the number of times the model incorrectly predicted acceptable path behavior. True negatives and positives may refer to the number of times the model correctly predicted whether the behavior of the path will be acceptable or unacceptable, respectively. Related to these measurements are the concepts of recall and precision. Generally, recall refers to the ratio of true positives to the sum of true positives and false negatives, which quantifies the sensitivity of the model. Similarly, precision refers to the ratio of true positives the sum of true and false positives.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method comprising:
receiving, at an application server, a request for a service to be initiated in relation to a user equipment;
providing, by the application server to a second computing device, a query related to the user equipment;
receiving, by the application server, information related to a current status of the user equipment in response to the query;
making, by the application server based on policy data associated with the service and the information related to the current status of the user equipment, an initiation decision related to the service;
providing, by the application server to the user equipment, instructions to initiate the service based on the initiation decision.

2. The method of claim 1, wherein the current status of the user equipment comprises at least one of geographic coordinates, a cell identifier, a PLMN code, or a RAT type associated with the user equipment.

3. The method of claim 1, wherein the initiation decision comprises a decision as to whether the service should be initiated.

4. The method of claim 1, wherein the policy data includes an indication of one or more regions and the initiation decision is made based on whether a current location of the user equipment indicated in the information related to the current status of the user equipment is within the one or more regions.

5. The method of claim 1, wherein the policy data includes an indication of a radio access type and the initiation decision is made based on whether RAT type of the user equipment indicated in the information related to the current status of the user equipment.

6. The method of claim 1, wherein the policy data includes an indication of a set of cell identifiers and the initiation decision is made based on whether a current cell identifier associated with the user equipment is within the set of cell identifiers.

7. The method of claim 1, wherein the application server does not communicate with the user equipment between receiving the request for the service and providing the instructions to initiate the service.

8. The method of claim 1, wherein providing the instructions to initiate the service comprises providing the instructions to a S-CSCF node assigned to the user equipment.

9. The method of claim 8, wherein the S-CSCF node is assigned to the user equipment during a registration process for the user equipment.

10. An application server computing device comprising:
one or more processors; and
one or more non-transitory computer-readable media storing computer-executable instructions that, when executed by the one or more processors, cause the application server computing device to perform operations comprising:
receive a request for a service to be initiated in relation to a user equipment;
provide, to a second computing device, a query related to the user equipment;
receive information related to a current status of the user equipment in response to the query;
make, based on policy data associated with the service and the information related to the current status of the user equipment, an initiation decision related to the service;
provide, to the user equipment, instructions to initiate the service based on the initiation decision.

11. The computing device of claim 10, wherein the second computing device comprises a home subscriber server (HSS).

12. The computing device of claim 11, wherein the HSS is caused to forward the query to a mobile management entity (MME) for the information related to the current status of the user equipment.

13. The computing device of claim 10, wherein the policy data comprises an indication of one or more conditions during which the user equipment is authorized to initiate the service.

14. The computing device of claim 13, wherein the one or more conditions are determined based on a level of service attributed to an account associated with the user equipment.

15. The computing device of claim 14, wherein the level of service attributed to the account is provided to the application server by the second computing device.

16. A system comprising:
a mobile management entity (MME) configured to:
upon receiving a first query for current status information about a user equipment, retrieve and provide the current status information about the user equipment in a response to the first query;
a home subscriber server (HSS) configured to:
upon receiving a second query related to the user equipment:
identify the MME as being associated with the user equipment;
submit the first query to the MME; and
forward the current status information about the user equipment as received from the MME to an application server; and
the application server configured to:
upon receiving a request to initiate a service at the user equipment, submit the second query to the HSS;
upon receiving the current status information about the user equipment from the HSS, determine whether to initiate the service; and
upon determining that the service is to be initiated, provide a communication to the user equipment.

17. The system of claim 16, wherein the communication comprises a session initiation protocol (SIP) invite communication.

18. The system of claim 16, wherein the application server is further configured to not provide any message to the user equipment prior to providing the communication to the user equipment.

19. The system of claim 16, wherein the service comprises service providing at least one of voice, video or text messaging provided over an IMS network.

20. The system of claim 16, wherein the HSS is further configured to provide, to the application server, account information related to the user equipment, and wherein the application server is further configured to determine whether to initiate the service based on the account information.
